(19) United States
(12) Patent Application Publication
(10) Pub. No.: US 2007/0261093 A1
(43) Pub. Date: Nov. 8, 2007

(54) BUFFERING VIDEO DATA AS RECEIVED OVER ALTERNATIVE NETWORKS

(75) Inventor: Markus ANDREASSON, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/530,291

(22) Filed: Sep. 8, 2006

Related U.S. Application Data
(60) Provisional application No. 60/745,313, filed on Apr. 21, 2006.

(51) Int. Cl. H04N 7/173; H04N 7/16

(52) U.S. Cl. 725/126; 725/62; 725/105; 725/120

(57) ABSTRACT

A method includes receiving, via a portable electronic communication device, first digital video data in bursts using a first communication technology. The method further includes receiving second digital video data in bursts using a second communication technology, the second communication technology being different than the first communication technology, processing the received first digital video data for presenting the first video data by the portable electronic communication device, processing the received second digital video data enabling presenting the second digital video data by the portable electronic communication device; presenting the processed first digital video data, detecting selection of second digital video data to be presented by the portable electronic communication device, providing the processed second digital video data for presenting by the portable electronic communication device in response to the detecting and presenting the provided processed second digital video.

### RELATED APPLICATION

This application claims priority under 35 U.S.C. § 119 based on U.S. Provisional Application Ser. No. 60/745,313, filed Apr. 21, 2006, the disclosure of which is incorporated herein by reference.

### FIELD OF THE INVENTION

Embodiments of the invention relate in general to reception of media data, and in particular to a method of and a portable electronic communication device for receiving digital video data, as well as a computer program product for carrying out program steps in accordance with embodiments of the invention.

### BACKGROUND OF THE INVENTION

Hand-held electronic devices (e.g., mobile phones) provide an increasing amount of features related to providing various types of media content. It is now possible for users of hand-held electronic devices to receive media, such as TV broadcasts (e.g., TV programs).

Various segments of mobile phones are available of which some are provided with the functionality to receive TV programs, whereas others do not comprise such functionality, possibly due to price, weight, size and/or design.

One technology to transmit media to an electronic device is to broadcast the media, for instance, as TV programs. Digital video broadcasting (DVB) is one such example of which DVB-handheld (DVB-H) in particular is one way to provide digital media to hand-held electronic devices by broadcasting the digital media to such hand-held electronic devices, of which mobile phones are examples of one type.

One problem connected to digital transmission of data using the DVB-H standard is the relatively long “zapping time”, i.e. the time it takes to switch from one channel or media stream to another channel or media stream. When a user selects a new channel or starts the DVB-H application, it may take a few seconds until data from the chosen new channel can be presented. The main reason for this long duration is that DVB-H data is broadcasted in the form of bursts in intervals having off-times of several seconds in between. This time delay may be annoying to a user who is switching channels or is starting the DVB-H application, that is, to a user initiating presentation of novel DVB-H data.

### SUMMARY OF THE INVENTION

According to a first embodiment, a method includes receiving, via a portable electronic communication device, first digital video data in bursts using a first communication technology is disclosed. The method further includes receiving second digital video data in bursts using a second communication technology, the second communication technology being different than the first communication technology, processing the received first digital video data for presenting the first video data by the portable electronic communication device, processing the received second digital video data enabling presenting the second digital video data by the portable electronic communication device, presenting the processed first digital video data, detecting selecting second digital video data to be presented by the portable electronic communication device, providing the processed second digital video data for presenting by the portable electronic communication device in response to the detecting, and presenting the provided processed second digital video.

A second embodiment is directed towards a method including the features of the first embodiment, wherein the processing the received first digital video data comprises buffering the received first digital video data.

A third embodiment is directed towards a method including the features of the second embodiment, wherein the processing the received second digital video data comprises buffering the received second digital video data.

A fourth embodiment is directed towards a method including the features of the first embodiment, further comprising receiving second digital video data in bursts using the first communication technology.

A fifth embodiment is directed towards a method including the features of the fourth embodiment, further comprising processing the second video data as received by using the first communication technology for presenting by the portable electronic communication device.

A sixth embodiment is directed towards a method including the features of the fifth embodiment, further comprising providing the processed second digital video data as received using the first communication technology for presentation.

A seventh embodiment is directed towards a method including the features of the sixth embodiment, wherein presenting the processed second digital video data as received using the second communication technology is performed in dependence of providing the processed digital second video data as received using the first communication technology for presentation.

An eighth embodiment is directed towards a method including the features of the sixth embodiment, further comprising presenting the processed second digital video data as received using the first communication technology by the portable electronic communication device.

A ninth embodiment is directed towards a method including the features of the first embodiment, wherein the first communication technology comprises a digital video broadcasting-handheld (DVB-H) communication technology.

A tenth embodiment is directed towards a method including the features of the first embodiment, wherein the second communication technology comprises one or more of GPRS communication technology, 3G communication technology, Bluetooth communication technology, or W-LAN communication technology.

An eleventh embodiment is directed towards a method including the features of the first embodiment, wherein the receiving second digital video data comprises receiving at least third digital video data in bursts using the second communication technology.

A twelfth embodiment is directed towards a method including the features of the eleventh embodiment, wherein the processing second digital video data comprises processing the received third digital video data enabling presenting the third digital video data by the portable electronic communication device.

According to a thirteenth embodiment, a portable electronic communication comprises a first data receiving unit arranged to receive first digital video data in bursts using a first communication technology, a second data receiving unit arranged to receive second digital video data in bursts using a second communication technology, the second communication technology being different than the first communication technology, a processing unit arranged to process the first digital video data received using the first communication technology and arranged to process the second digital video data received using the second communication technology for enabling presentation of the processed first video data and second video data, a user input unit arranged to receive user selection of second digital video data for presentation, and a control unit arranged to control processing of first and second digital video data, to provide processed second digital video data for presentation, and to control presenting provided processed second digital video data as received using the second communication technology.

A fourteenth embodiment is directed towards a portable electronic communication device including the features of the thirteenth embodiment, further comprising a visual information presentation unit, and wherein the control unit is arranged to control presenting digital video data using the visual presentation unit.

A fifteenth embodiment is directed towards a portable electronic communication device including the features of the thirteenth embodiment, wherein the processing unit further is arranged to cause the first digital video data as received in bursts using the first communication technology to be buffered.

A sixteenth embodiment is directed towards a portable electronic communication device including the features of the thirteenth embodiment, wherein the processing unit further is arranged to cause the second digital video data as received in bursts using the second communication technology to be buffered.

A seventeenth embodiment is directed towards a portable electronic communication device including the features of the thirteenth embodiment, wherein the first data receiving unit further is arranged to receive second digital video data in bursts using the first communication technology.

An eighteenth embodiment is directed towards a portable electronic communication device including the features of the seventeenth embodiment, wherein the processing unit further is arranged to process the second digital video data as received using the first communication technology.

A nineteenth embodiment is directed towards a portable electronic communication device including the features of the eighteenth embodiment, wherein the control unit is arranged to control presenting the processed second digital video data as received using the second communication technology in dependence of providing the processed digital second video data as received using the first communication technology, for presentation.

A twentieth embodiment is directed towards a portable electronic communication device including the features of the thirteenth embodiment, wherein the first data receiving unit comprises a digital video broadcasting-handheld (DVB-H) receiver arranged to receive broadcasted DVB-H video data.

A twenty-first embodiment is directed towards a portable electronic communication device including the features of the thirteenth embodiment, wherein the second communication technology comprises one or more of GPRS communication technology, 3G communication technology, Bluetooth communication technology, or W-LAN communication technology.

A twenty-second embodiment is directed towards a portable electronic communication device including the features of the thirteenth embodiment, wherein the portable communication device includes a mobile phone.

According to a twenty-third embodiment, a computer program product comprising a computer readable medium having thereon computer readable code, to make a computer or a portable electronic communication device perform, when the computer readable code is loaded in the computer or the portable electronic communication device, a method comprising receiving first digital video data in bursts using a first communication technology, receiving second digital video data in bursts using a second communication technology, the second communication technology being different than the first communication technology, processing the received first digital video data for presenting the first video data by the computer or the portable electronic communication device, processing the received second digital video data enabling presenting the second digital video data by the computer or the portable electronic communication device, presenting the processed first digital video data, detecting selection of second digital video data to be presented by the computer or the portable electronic communication device, providing the processed second digital video data, as received using the second communication technology, for presenting by the computer or the portable electronic communication device in response to the detecting, and presenting the provided processed second digital video as received using the computer or the portable electronic communication device.

### BRIEF DESCRIPTION OF THE DRAWINGS

Embodiments of the invention will now be described in more detail in relation to the enclosed drawings, in which:

FIG. 1 schematically shows a portable electronic communication device according to one embodiment of the invention,

FIG. 2 presents a flow chart of an exemplary method of processing digital video data according to one embodiment of the invention,

FIG. 3 displays a portable electronic communication device in the form of a mobile phone, according to one embodiment of the invention, and

FIG. 4 illustrates a computer program product, having thereon computer program code to make a portable electronic communication device or a computer execute steps in line with the methods of the invention according to one embodiment of the invention.

### DETAILED DESCRIPTION OF THE EMBODIMENTS

Embodiments consistent with principles of the invention receive burst data over a network different from the network normally used for a special application. By making use of receiving information transmitted in bursts over this alternative network, such information can be made available to a portable electronic communication device without the need to wait for receipt of the data burst using the normally used network. By applying this idea to changing selection of channel using DVB-H, the zapping time can be considerably reduced.

When a user of a mobile phone, as one example of a portable electronic communication device, changes from channel A to channel B, channel B data may not be available to the mobile phone since the receiver of the mobile phone may be switched off between receiving channel A bursts. Since channel B bursts may be transmitted with a time interval of approximately 3-4 seconds, the waiting time as experienced by the user would be reduced if channel B data could be made available to the mobile phone prior to receiving a new channel B burst by the mobile phone.

One way to obtain channel B data is to receive channel B data over an alternative network using another communication technology as compared to the communication technology that is used when receiving channel A data, or rather the data channel which the user stops consuming when the user selects the new channel to experience, which new channel in this case being channel B.

When a user is consuming a channel that is received over the DVB-H network, the data that is consumed is transmitted in bursts at regular intervals. These intervals may be approximately 3-4 seconds long. Since the data to be consumed is transmitted in bursts, the received data is buffered in a buffer, such as a playing buffer. When the playing buffer is filled to a certain level, the data contained therein may be sent to a data presentation unit for presentation to a user.

In order to enable a user to consume data that is transmitted in bursts to be received over an alternative network, this data may also be buffered. Data that a user may select to consume is buffered in a backup buffer. When the backup buffer is filled to a certain level, the data contained therein may be erased. In this way, only data from the latest burst is buffered in the backup buffer.

When the user thereafter decides to stop watching or consuming channel A and start consuming channel B, the backup buffer containing channel B data may become the playing buffer and the playing buffer may become the backup buffer. Channel A data as received in bursts over DVB-H network may thus be stored in the backup buffer, whereas channel B data as receive over the alternative network using a second communication technology may be buffered in the playing buffer.

When the playing buffer is filled to a certain level, the data contained therein may be sent to the data presentation unit for presentation to the user, similar to the case previously described for channel A data.

Moreover, when the backup buffer is filled to a certain level, the data contained therein may be erased. In the example above, channel A data may be erased.

However, channel B data as received over the alternative network is intended to be an intermittent solution to providing channel B data to the user. After a certain amount of time (e.g., up to 3-4 seconds), a novel channel B data burst may be transmitted over the DVB-H network and may thus be received. After processing of such a received channel B burst, channel B data as received using DVB-H may thus be presented to the user.

As it is known to use a Z-channel that is a zapping channel, which contains data from a number of channels (e.g., this typically is all or most channels that are available to a user), it is easily envisaged to use a Z-channel in connection with implementations consistent with the invention. In case a Z-channel data is being transmitted in bursts over an alternative network using a second communication technology, data from a number of channels may be received. The Z-channel data may be buffered in the same manner as described above in connection to channel B data.

As the user selects a new channel to consume, for instance channel B, the backup buffer containing data from a number of channels becomes the playing buffer, from which channel B data is extracted. The channel B data may then be presented.

Upon receipt of a channel B data burst over the DVB-H network, this data may be buffered in the playing buffer, whereas receipt of a channel Z data burst may be buffered in the backup buffer, in analogy with the previous example as presented above.

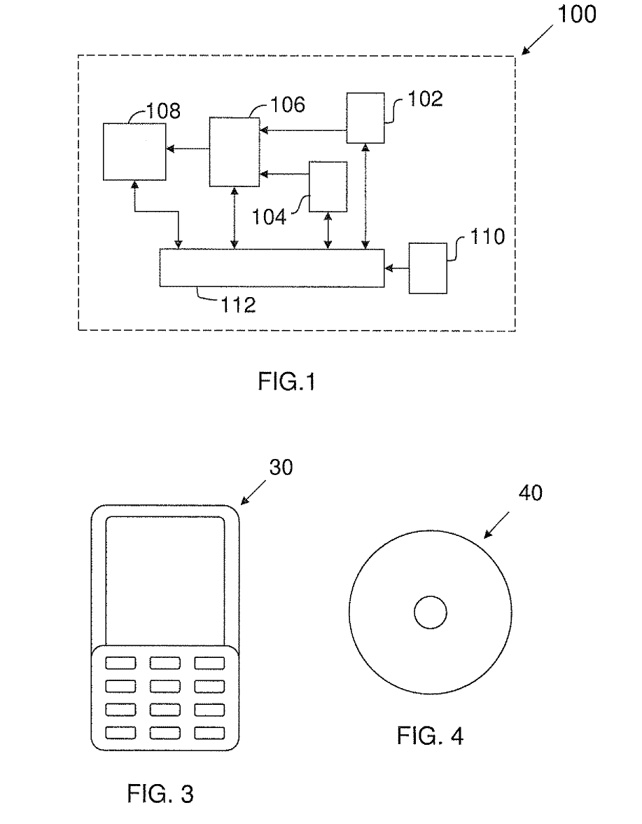

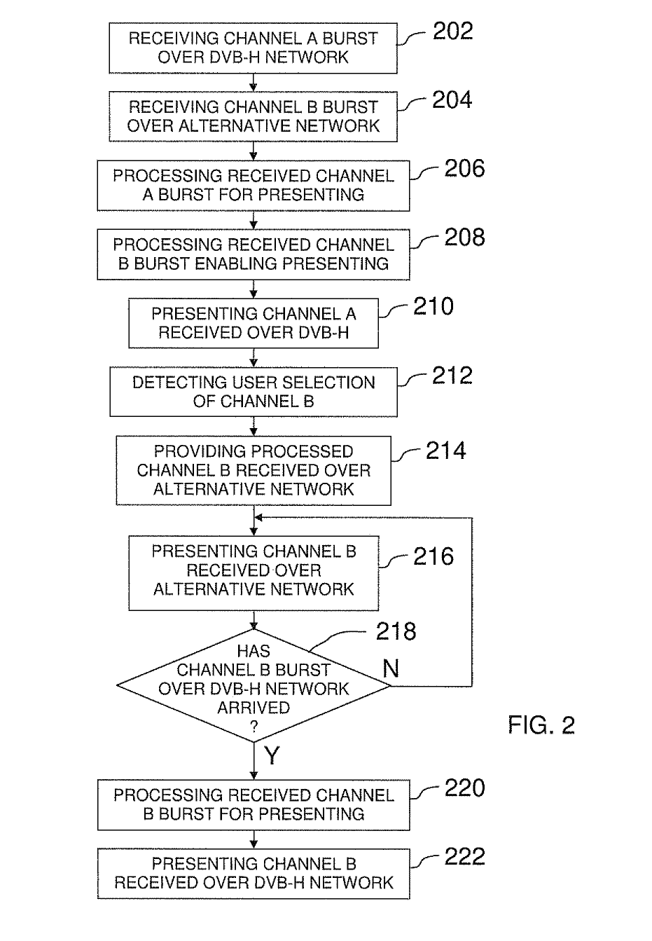

With reference to FIGS. 1 and 2, schematically showing a portable electronic communication device according to one embodiment of the invention, and presenting a flow chart of an exemplary method of processing digital video data, according to one embodiment of the invention, by a portable electronic communication device 100, respectively, one embodiment of the invention explained in more detail.

According to this embodiment, the portable communication device 100 comprises a first data receiving unit 102, a second data receiving unit 104, a processing unit 106, a data presentation unit 108, a user input unit 110 and a control unit 112. As shown in FIG. 1, and according to this embodiment, the first data receiving unit 102 and the second data receiving unit 104 are connected to the processing unit 106, which is connected to the data presentation unit 108. These four units may connect to the control unit 112, to which the user input unit 110 may further be connected.

The flow-chart of the FIG. 2 shows an exemplary method of processing digital video data, such as DVB-H channel A or DVB-H channel B data as two examples of digital video broadcast handheld data, by a portable electronic communication device 100, such as a mobile phone.

According to this embodiment, processing may begin with portable electronic communication device 100, receiving a channel A burst over a DVB-H network (block 202), where the channel A burst is one example of a first digital video data and where the DVB-H network is one example of a first communication technology. In one embodiment, the receiving may be performed by the first data receiving unit 102 under the control of the control unit 112.

Portable electronic communication device 100 may receive a channel B burst over an alternative network (block 204). Receiving the channel B burst may be performed by a data receiving unit 104 under the control of the control unit 112.

In one embodiment, receiving channel B burst data (block 204) may occur after receiving channel A burst data (block 202). The relative order of these two acts is, however, irrelevant.

After receiving channel A data in form of a burst, portable electronic communication device 100 may process the received channel A burst for presenting (block 206). Processing the received channel A burst may include storing the received burst in a buffer from which data is taken when presenting data. As set forth above, such a buffer may be called a playing buffer. This processing may be executed by the processing unit 106 under the control of the control unit 112.

The received channel B burst may be processed to enable presenting (block 208). This processing may include storing the received channel B burst in a buffer that is used for making a backup of received channel B data. This processing may be performed by the processing unit 106 under the control of the control unit 112.

Having received channel A burst and processed the channel A burst data, channel A data received over the DVB-H network may be presented (block 210). The presenting may be performed by the data presentation unit 108 under control of the control unit 112 and in dependence of the processing unit 106.

Assume that portable electronic communication device 100 detects user selection of channel B (block 212). The detection may be performed by the user input unit 110 with subsequent delivering of a detection signal to the control unit 112. Detecting user selection of channel B means that the user has chosen to stop consuming a certain channel, in this case, channel A, and instead has selected to start consuming channel B.

After having detected that a user wishes to change channel or zap from channel A to channel B, in this example, processed channel B data may be provided as received over alternative network (block 214). The providing may be performed by the processing unit 106, again under control of the control unit 112.

Providing processed channel B data may include switching the backup buffer in which channel B burst is buffered to become the buffer from which data may be taken when data is consumed (e.g., making the backup buffer the playing buffer).

Having provided the processed channel B data as received over the alternative network, the channel B data as received over the alternative network may be presented (block 216). As channel B data was available in the backup buffer, it can quickly be presented to the user.

Presenting channel B data over an alternative network may minimize or even eliminate the zapping time as experienced by a user when changing channel to consume. As only one full band width DVB-H channel is received by one receiver in the DVB-H standard, and since the receiver is switched off between receiving the bursts, channel B data is typically not available to consume at the time of detecting selection of a user.

As the user chooses to consume channel B, channel B data over the DVB-H network is not yet available, as this data is transmitted in bursts and only one channel is tuned into at a time.

A certain time after having detected the user selection of channel B (e.g., typically about 3-4 seconds), a novel channel B burst may arrive. Portable electronic communication device 100 may determine whether or not a channel B burst as transmitted over the DVB-H has arrived (block 218). If the novel channel B burst has not arrived, presenting channel B as received over the alternative network may continue (block 216).

In one embodiment, presenting channel B data may include presenting channel B data as received from more than one channel B burst, in case a channel B burst has not been received over the DVB-H network, at an early stage. Receiving channel B over the DVB-H network may be performed by the first data receiving unit 102.

Having determined that channel B has been received over the DVB-H network, portable electronic communication device 100 may process the received channel B burst for presenting (block 220). This processing may be performed by the processing unit 106 under the control of the control unit 112. Portable electronic communication device 100 may present channel B data, as received over the DVB-H network, to the user.

As indicated above, the second digital video data may be a zapping channel containing digital video data from more than one channel.

FIG. 3 displays a portable electronic communication device 30 in the form of a mobile phone, according to one embodiment of the invention. It will be appreciated that portable electronic communication device 100 may include other types of communication devices.

FIG. 4 schematically depicts a computer program product 40 according to one embodiment of the invention, having thereon computer program code. When the computer program code, included on a computer program product, is loaded in a computer or portable electronic communication device, the computer or portable electronic communication device, may perform a method including receiving first digital video data in bursts using a first communication technology, receiving second digital video data in bursts using a second communication technology, processing the received first digital video data for presenting the first video data by the computer or the portable electronic communication device, processing the received second digital video data enabling presenting the second digital video data by the computer or the portable electronic communication device, presenting the processed first digital video data, detecting selecting second digital video data to be presented by the computer or the portable electronic communication device, providing the processed second digital video data, as received using the second communication technology, for presenting by the computer or the portable electronic communication device, and presenting the provided processed second digital video as received using the computer or the second communication technology, so that a user quickly can be presented selected digital video data

The computer program product may be provided as a CD-ROM disc according to one embodiment of the invention. However, the computer program product 40 can alternatively be provided as another type of disc such as a DVD disc, a hard disc, or be provided as a memory or other storage capacity, such as a flash-based memory, for example a memory stick or a USB (Universal Serial Bus) memory or a type of volatile memory.

Embodiments consistent with principles of the invention significantly reduce the zapping time while retaining the available bandwidth for the digital video data (e.g., keeping the number of digital video channels unchanged).

It should be emphasized that the term “comprises/comprising” when used in this specification is taken to specify the presence of stated features, integers or steps, but does not preclude the presence or addition of one or more other features or steps.

It is emphasized that this invention can be varied in many ways, of which the alternative embodiments above and below only are a few examples. These different embodiments are hence non-limiting examples.

The second alternative network or communication technology may comprise any type of wireless, wired, or optical communication technology. In one embodiment, the second alternative communication technology may include the Bluetooth communication technology, the general packet radio service (GPRS) communication technology, 3G communication technology, or W-LAN communication technology.

Needless to say channel A and channel B only denote examples of possible channels or programs to be consumed.

While a series of acts has been described with respect to FIG. 2, the order of the acts may be varied in other implementations consistent with the invention. Moreover, non-dependent acts may be implemented in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit, a field programmable gate array, a processor, or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method, comprising:
receiving, via a portable electronic communication device, first digital video data in bursts using a first communication technology;
receiving second digital video data in bursts using a second communication technology, the second communication technology being different than the first communication technology;
processing the received first digital video data for presenting the first video data by the portable electronic communication device;
processing the received second digital video data enabling presenting the second digital video data by the portable electronic communication device;
presenting the processed first digital video data;
detecting selection of second digital video data to be presented by the portable electronic communication device;
providing the processed second digital video data for presenting by the portable electronic communication device in response to the detecting; and
presenting the provided processed second digital video.

2. Method according to claim 1, wherein the processing the received first digital video data comprises:
buffering the received first digital video data.

3. Method according to claim 2, wherein the processing the received second digital video data comprises:
buffering the received second digital video data.

4. Method according to claim 1, further comprising:
receiving second digital video data in bursts using the first communication technology.

5. Method according to claim 4, further comprising:
processing the second video data as received using the first communication technology for presenting by the portable electronic communication device.

6. Method according to claim 5, further comprising:
providing the processed second digital video data as received using the first communication technology for presentation.

7. Method according to claim 6, wherein presenting the processed second digital video data as received using the second communication technology is performed in dependence of providing the processed digital second video data as received using the first communication technology for presentation.

8. Method according to claim 6, further comprising:
presenting the processed second digital video data as received using the first communication technology by the portable electronic communication device.

9. Method according to claim 1, wherein the first communication technology comprises a digital video broadcasting-handheld (DVB-H) communication technology.

10. Method according to claim 1, wherein the second communication technology comprises one or more of GPRS communication technology, 3G communication technology, Bluetooth communication technology, or W-LAN communication technology.

11. Method according to claim 1, wherein the receiving second digital video data comprises:
receiving at least third digital video data in bursts using the second communication technology.

12. Method according to claim 11, wherein the processing second digital video data comprises:
processing the received third digital video data enabling presenting the third digital video data by the portable electronic communication device.

13. Portable electronic communication device comprising:
a first data receiving unit arranged to receive first digital video data in bursts using a first communication technology;
a second data receiving unit arranged to receive second digital video data in bursts using a second communication technology, the second communication technology being different than the first communication technology;
a processing unit arranged to process the first digital video data received using the first communication technology and arranged to process the second digital video data received using the second communication technology for enabling presentation of the processed first video data and second video data;
a user input unit arranged to receive user selection of second digital video data for presentation; and
a control unit arranged to control processing of first and second digital video data, to provide processed second digital video data for presentation, and to control presenting provided processed second digital video data as received using the second communication technology.

14. Portable electronic communication device according to claim 13, further comprising:
a visual information presentation unit, and
wherein the control unit is arranged to control presenting digital video data using the visual information presentation unit.

15. Portable electronic communication device according to claim 13, wherein the processing unit further is arranged to cause the first digital video data as received in bursts using the first communication technology to be buffered.

16. Portable electronic communication device according to claim 13, wherein the processing unit further is arranged to cause the second digital video data as received in bursts using the second communication technology to be buffered.

17. Portable electronic communication device according to claim 13, wherein the first data receiving unit further is arranged to receive second digital video data in bursts using the first communication technology.

18. Portable electronic communication device according to claim 17, wherein the processing unit further is arranged to process the second digital video data as received using the first communication technology.

19. Portable electronic communication device according to claim 18, wherein the control unit is arranged to control presenting the processed second digital video data as received using the second communication technology in dependence of providing the processed digital second video data as received using the first communication technology, for presentation.

20. Portable electronic communication device according to claim 13, wherein the first data receiving unit comprises a digital video broadcasting-handheld (DVB-H) receiver arranged to receive broadcasted DVB-H video data.

21. Portable electronic communication device according to claim 13, wherein the second communication technology comprises one or more of GPRS communication technology, 3G communication technology, Bluetooth communication technology, or W-LAN communication technology.

22. Portable communication device according to claim 13, wherein the portable communication device includes a mobile phone.

23. Computer program product comprising a computer readable medium having thereon computer readable code, to make a computer or a portable electronic communication device perform, when said computer readable code is loaded in the computer or the portable electronic communication device, a method comprising:
receiving first digital video data in bursts using a first communication technology;
receiving second digital video data in bursts using a second communication technology, the second communication technology being different than the first communication technology;
processing the received first digital video data for presenting the first video data by the computer or the portable electronic communication device;
processing the received second digital video data enabling presenting the second digital video data by the computer or the portable electronic communication device;
presenting the processed first digital video data;
detecting selection of second digital video data to be presented by the computer or the portable electronic communication device;
providing the processed second digital video data, as received using the second communication technology, for presenting by the computer or the portable electronic communication device in response to the detecting; and
presenting the provided processed second digital video as received using the computer or the portable electronic communication device.
